(19) United States
(12) Patent Application Publication
(10) Pub. No.: US 2022/0072483 A1
(43) Pub. Date: Mar. 10, 2022

(54) MEMBRANE AND METHOD OF PRODUCING THE SAME

(71) Applicant: G20 Water Technologies Limited, Monchester (GB)

(72) Inventors: Kangsheng LIU, Manchester (GB); David PEARS, Manchester (GB); Chris WYRES, Manchester (GB)

(21) Appl. No.: 17/416,676

(22) PCT Filed: Dec. 20, 2019
(86) PCT No.: PCT/GB2019/053648

§ 371 Date: Jun. 21, 2021

(30) Foreign Application Priority Data
Dec. 21, 2018 (GB) 1821126.8

(51) Int. Cl. B01D 71/02; B01D 67/00; B01D 69/02; B01D 69/10; B01D 69/14

(52) U.S. Cl. CPC B01D 71/024; B01D 67/0069; B01D 67/0093; B01D 69/02; B01D 2325/26; B01D 67/0095; B01D 69/14; B01D 2325/02; B01D 2325/22; B01D 69/105

(57) ABSTRACT

A separation membrane suitably for water separation. The membrane includes a porous substrate layer and an active layer arranged over at least a part of the substrate layer. The active layer includes a lamellar structure comprising at least two layers of treated two-dimensional material.

### FIELD

The present invention relates to separation membranes. More specifically, the present invention relates to the post-coating treatment of membranes containing two-dimensional material and to the production of membranes having different coating layers of two-dimensional material.

### BACKGROUND

Membrane separation uses a porous material to separate a mixture of components, generally by the application of a driving force applied across the surface of membrane, such as pressure, or without an applied driving force, such as by gravity.

Membrane separation may be applied to separate liquid from liquid, solid from liquid, ions from liquid, liquid from gas, gas from gas.

Membrane separation is favoured over other water treatment or separation technologies due to, in principle, lower cost, less space required for installation, no significant thermal input, lower energy consumption, reduced chemical treatments, higher removal efficiency and a lower requirement for the regeneration of spent media. Membrane separation can be applied widely in water treatment, for the removal of solids, particulates, organic molecules, dissolved species, ions, microorganisms, dye molecules, bacteria and natural organic materials, milk condensation, viruses. Membrane separations are used in many different applications from industrial waste water treatment, domestic water purification, food and beverage processing, dairy processing, laundry water treatment, landfill leachate, paper pulp effluent, fine chemical production, oily water treatment to seawater desalination.

Typically, separation membranes are categorised in accordance with the characteristic pore size or intended applications. Microfiltration membranes (MF), with pore sizes in a range of 0.1 um to 100 um, can be used to remove bacteria, cysts, yeast cells, suspending particles, pigments, and asbestos. Ultrafiltration membranes (UF), having pore sizes in a range of 0.01 um and 0.1 um, can be used to remove proteins, colloidal particles and viruses. Nanofiltration membranes (NF), with pore sizes in the range of from 0.001 to 0.01 um, can be used to select multivalent ions, dissolved compounds, medium sized organic molecules, small proteins, small colloidal particles. Reverse osmosis membranes (RO), with pore sizes smaller than 0.001 um, can be used to remove ions and small organic molecules.

Currently, the commercially available separation membranes perform well in a wide range of applications; however, the drive to produce new clean water resources and protect existing water resources at lower capital and operating costs demands more advanced membranes having properties including improved and tuneable fouling resistance, size exclusion, higher selectivity, higher productivity at lower energy inputs, longer life span, improved chemical and mechanical resistance and fewer manufacturing defects. Accordingly, new materials, membrane systems and processing technologies having properties to fulfil the demands are desired.

Nanoporous materials may have application in water separation membranes, however, the use of such materials presents challenges in relation to scalability, mechanical strength, chemical robustness, life span, dissolution in liquid media, as well as the high cost of the materials and of the subsequent manufacturing processes required for their incorporation. Therefore, there is a requirement for improved membranes for separation, in particular for water treatment applications. It is therefore an object of aspects of the present invention to address one or more of the above mentioned or other problems.

### SUMMARY

According to a first aspect of the present invention, there is provided a separation membrane, suitably for water separation, comprising a porous substrate layer and an active layer arranged over at least a part of the substrate layer, wherein the active layer comprises a lamellar structure comprising at least two layers of treated two-dimensional material.

When used herein “treated” in relation to the two-dimensional material means two-dimensional material that has been subjected to a process after formation of a coating composition comprising the two-dimensional material and/or after application of the two-dimensional material to the substrate layer that has caused a change in the functional groups of the two-dimensional material, for example changed the number, species and/or distribution of the functional groups, compared to the functional groups of the two-dimensional material prior to treatment, and suitably prior to application of the two-dimensional material to the substrate. Preferably, after application of the two-dimensional material to the substrate layer.

According to a second aspect of the present invention there is provided a method of producing a separation membrane, suitably a membrane according to the first aspect of the present invention, the method comprising the steps of:
a. optionally preparing a substrate, optionally by treating the substrate with chemical treatment and/or radiation treatment, and/or plasma treatment, and/or thermal treatment;
b. contacting the substrate with a composition comprising a two-dimensional material, optionally by forming a first layer of the composition comprising a two-dimensional material and then applying a further layer of the composition comprising a two-dimensional material to the first layer; a layer may optionally be dried before application of the subsequent layer;
c. optionally, drying the membrane.
d. treating the two-dimensional material applied in step (b) to cause a change the functional groups of the two-dimensional material, such as by application of high energy radiation such as laser radiation, chemicals, heat, thermal heat and/or pressure to the two-dimensional material; optionally by treating a first layer of the composition before application and subsequent treatment of a further layer of the composition;
e. optionally, drying the membrane.

According to a third aspect of the present invention, there is provided a separation membrane, suitably for water separation, comprising a porous substrate layer and an active layer arranged over at least a part of the substrate layer, wherein the active layer comprises at least two coating layers each comprising a two-dimensional material, wherein at least one of the coating layers of the active layer is different to another coating layer of the active layer.

It will be apparent that the phrase “wherein at least one of the coating layers of the active layer is different to another coating layer of the active layer” relates to a substantive difference between the coating layers that results in a substantive difference in separation activity. It will also be apparent “different” does not include that one of the coating layers is positioned above the other.

The active layer of the membrane of the third aspect of the present invention may comprise one or more further coating layers wherein each coating layer may be the same as another coating layer or be different to the other coating layers.

A coating layer may comprise a different structure to another coating layer (e.g. due to the presence of nanochannels in the layer and/or a greater or lesser thickness), and/or comprise a different composition to another layer. A coating layer may comprise two-dimensional material having different functional groups, different amounts of functional groups, different structures (e.g. different particle/plate structures and/or sizes) to another layer. A coating layer may comprise additional additives to another layer and/or additional two-dimensional material.

Suitably, a coating layer of the active layer may comprise a lamellar structure comprising two-dimensional material.

According to a fourth aspect of the present invention, there is provided a method of producing a separation membrane, suitably a membrane according to the first or third aspect of the present invention, the method comprising the steps of:
a. optionally preparing a substrate, optionally by treating the substrate with chemical treatment and/or radiation treatment, and/or plasma treatment, and/or thermal treatment;
b. contacting the substrate with a composition comprising two-dimensional material to form a first coating layer;
c. applying one or more further coating layers of one or more compositions comprising two-dimensional material to the first layer; optionally drying one or more of the layers between application of the subsequent layer;
d. optionally, drying the membrane
wherein at least one of the coating layers is different to another coating layer.

At least one of coating compositions used to form the layers in the method according to the fourth aspect of the present invention may be different to another of the coating compositions.

The active layer of the membrane of the aspects of the present invention may comprise nanochannels, suitably the coating composition for forming the active layers comprises nanofibers. The nanochannels may have a diameter or width of from 1 to 100 nm. The method of the second aspect may comprise the step of removing the nanofibres by contacting the membrane with a mild acid.

According to a fifth aspect of the present invention, there is provided a membrane, suitably a membrane according to any aspect of the present invention, wherein the active layer comprises nanochannels having a diameter of from 1 to 100 nm.

According to a sixth aspect of the present invention, there is provided a method of producing a separation membrane, suitably a membrane according to any aspect of the present invention, the method comprising the steps of:
a. optionally preparing a substrate
b. contacting the substrate with a coating composition comprising two-dimensional material and nanofibres;
c. removing the nanofibres by contacting the membrane produced by step (b) with mild acid, such as an acid having a pH of from 1 to 6;
d. treating, and preferably reducing, the two-dimensional material, preferably by laser treatment, chemical treatment, and/or thermal treatment;
e. optionally, drying the membrane.

The membrane of the present invention may be for any type of separation, such as liquid separation, liquid/gas separation, gas/gas separation, liquid/solid separation. Suitably, the membrane of the present invention is for oil/water separation, molecule separation, pharmaceutical separation for removal of pharmaceutical residues in the aquatic environment, drug separation, bio-filtration, for example separation between micro-organisms and water, desalination, suitably sea water desalination, or selective ion separation, and nuclear waste water separation for removal of nuclear radioactive elements from nuclear waste water, heavy metal removal, bio-refinery, laundry water treatment, milk condensation, for blood treatment such as physiological separation to replace damaged kidney filter and blood separation, and/or separation of bio-platform molecules derived from sources such as plants, for example a grass, or for domestic water treatment, for industrial water treatment, for example, industrial laundry waste water, food and beverage manufacturing, chemical production waste water, paper processing, waste water from landfill and agriculture, dairy and cheese production including brine water treatment from cheese production, milk concentration, protein recovery from crops such as potatoes. Suitably the membrane is for oil/water separation and desalination.

The substrate layer of any aspect of the present invention may comprise any porous material operable to support the active layer during the separation process. The substrate may comprise one layer or multiple layers of the same or different porous materials. The different porous materials may differ in terms of chemical composition, thickness, morphology and/or structure.

The substrate may comprise a polymeric substrate, a polymeric substrate containing inorganic filler, a ceramic substrate, a composite substrate, a metal substrate, such as a thin film composite substrate, an inorganic substrate, inorganic-organic substrate, a metal substrate, woven filament, such as a woven mono-filament or a woven multi-filament, and/or non-woven, and/or a casted substrate. The woven filament and non-woven substrates may be formed of fibres having the same or different chemistry, for instance such substrates may comprise a first component formed of a first material and a second component formed of a second material, for example a mixture of polypropylene (PP) and polyethylene terephthalate (PET). Preferably, the substrate is a ceramic substrate or a polymeric substrate such as a polysulphone or polyether sulphone, polyamide substrate, polyvinylidene fluoride (PVDF), or a zeolite or alumina substrate, most preferably a polymeric substrate.

The substrate may be in the form of a porous film, porous plate, porous hollow fibre substrate, tubular fibre substrate, bulky porous material. Suitably the substrate is in the form of a film, preferably a substantially planar film.

The porous film may be selected from a ceramic porous film, a polymeric porous film, a polymeric non-woven film, and inorganic-organic porous films.

Suitably from polymeric porous film, or a polymeric non-woven film.

The substrate may contain at least two porous films, porous plates, porous fibre substrates, and/or bulky porous materials.

Advantageously, a substrate containing more than one porous film, porous plates, porous fibre substrates, and/or bulky porous materials canprovide improved mechanical properties, improved flux and/or reduce the cost.

A ceramic porous substrate may be formed from materials selected from one or more of zeolite, silicon, silica, alumina, zirconia, mullite, bentonite and montmorillonite clay substrate.

A polymeric porous woven or nonwoven substrate may be formed from materials selected from one or more of polyacrylonitrile (PAN), polyethylene terephthalate (PET), polycarbonate (PC), polyamide (PA), polysulfone (PSf), poly(ether) sulfone (PES), modified poly(ether) sulfone (m-PES), cellulose acetate (CA), poly(piperazine-amide), polyvinylidene fluoride (PVDF), polypropylene (PP), polytetrafluoroethylene (PTFE), poly(phthalazinone ether sulfone ketone) (PPESK), polyamide-urea, poly (ether ether ketone), polypropylene, poly(phthalazinone ether ketone), and thin film composite porous films (TFC), suitably the TFC comprises an ultra-thin ‘barrier’ layer polymerised in situ over a porous polymeric support membrane, such as commercially available polyamide derived TFCs of an interfacially synthesized polyamide formed over a polysulphone membrane, and/or other TFCs such as poly(piperazine-amide)/poly(vinyl-alcohol) (PVA), poly(piperazine-amide)/poly(phthalazinone biphenyl ether sulfone (PPBES), hydrolyzed cellulose tri-acetate (CTA)/Cellulose acetate (CA) TFCs, chlorinated polyvinyl chloride (CPVC), polylactic acid (PLA), PET/PP, or mixture of different polymers, such as non-woven, or composite layers, such as with a supportive layer coated with a cast layer on top of the the supporting layer.

The polymeric substrate for deposition may be selected from one or more of polyamide (PA), polysulphone (PSf), polyvinylidene fluoride (PVDF), polycarbonate (PC), cellulose acetate (CA), tricellulose acetate (TCA), polyethylene terephthalate (PET), poly (ether) sulphone (PES), modified poly(ether) sulfone (m-PES), polypropylene (PP), polyacrylonitrile (PAN), thin film composites (TFC), such as polysulphone supported polyamide composite substrate, chlorinated polyvinyl chloride (CPVC), polylactic acid (PVA), PET/PP.

The substrate may comprise a non-wovensubstrate, or composite substrate wherein the substrate comprises a mixture of different polymers, such as a substrate comprising a supportive layer coated with cast layer on top of the supporting layer..

Preferably, the polymeric substrate is selected from one or more of polyamide (PA), polysulphone (PSf), polyvinylidene fluoride (PVDF), and thin film composite (TFC), such as polysulphone supported polyamide composite substrate,

The porous substrate may be a nanotechnology-based porous substrate, such as nanostructured ceramic porous substrate, inorganic-organic porous substrate, non-woven nano-porous fabric, and/or nanoparticle doped membrane.

The nanostructured ceramic porous substrate may be formed of two or more layers, suitably a first layer comprising a conventional pressure driven ceramic material, such as one or more of zeolite, titanium oxide, alumina, zirconia, etc., suitably with a second layer extending over at least a portion of the first layer, the second layer may be synthesized zeolite, titanium oxide, alumina, such as via hydrothermal crystallisation or dry gel conversion methods. Other nanostructured ceramic porous substrates may be reactive or catalyst coated ceramic surfaced substrates. Such substrates may advantageously lead to strong interaction with the active layer and improve the stability of the filters.

An inorganic-organic composite porous substrate may be formed from inorganic particles contained in a porous organic polymeric substrate. An inorganic-organic composite porous substrate may be formed from materials selected from zirconia nanoparticles with polysulphone porous membrane. Advantageously, an inorganic-organic composite porous substrate may provide a combination of an easy to manufacture lower cost substrate having good mechanical strength and/or improved selectivity, for example improved oil separation. An inorganic-organic porous substrate, such as zirconia nanoparticles with polysulphone may advantageously provide elevated permeability. Other inorganic-organic porous substrates may be selected from thin film nanocomposite substrates comprising one or more type of inorganic particle; metal-based foam (such as aluminium foam, copper foam, lead foam, zirconium foam, stannum foam, and gold foam); mixed matrix substrates comprising inorganic fillers in an organic matrix to form organic-inorganic mixed matrix.

The porous substrate may comprise a non-woven nano fabric. Advantageously, a non-woven nano fabric provides high porosity, high surface area, and/or controllable functionalities. The non-woven fabric may comprise fibres with diameter at nanoscale. The non-woven fabric may be formed of cellulose acetate, cellulose, polyethylene terephthalate (PET), polyolefins such as polyethylene and polypropylene, and/or polyurethane, suitably by electrospinning, suitably using cellulose acetate and polyurethane.

The substrate may be manufactured as flat sheet stock, plates or as hollow fibres and then made into one of the several types of membrane substrates, such as hollow-fibre substrate, tubular substrate or spiral-wound membrane substrate. Suitable flat sheet substrates may be obtained from Dow Filmtec and GE Osmonics.

Advantageously, a substrate in the form of a porous polymeric substrate can provide improved ease in processing and/or low cost.

The substrate layer may have any suitable pore size. The average size of the pores of the substrate may be from 0.1 nm to 30,000 nm depending on application, preferably from 200 nm to 5000 nm. The substrate is typically a microfiltration or ultrafiltration membrane.

The pore size of the substrate layer may be from 0.1 nm to 100,000 nm, such as from 0.5 nm to 50,000 nm, from 1 nm to 25,000 nm, from 5 nm to 20,000 nm, from 10 nm to 10,000 nm, such as from 50 nm to 9,000 nm, from 100 nm to 8,500 nm, from 100 nm to 8,000 nm, from 120 nm to 8,000 nm, from 150 nm to 7,500 nm, such as from 200 nm to 5,000 nm. Preferably, the pore size of the substrate is smaller than the particles of the two-dimensional material. For example, should the graphene be in the form of particles having a size of 500 nm, the pore size of the porous substrate is preferably smaller than 500 nm.

The substrate may have any suitable thickness. The thickness of the substrate may be between 0.1 to 20,000 μm, or from 0.1 to 15,000 μm, such as between 0.5 to 10,000 μm, or between 1 to 5,000 μm, or between 3 and 2,500 μm, preferably between 5 and 1,500 μm more preferably between 10 and 1,200 μm, such as between 15 and 1,000 μm, or between 20 and 900 μm, such as between 25 and 800 μm. Optionally, the substrate may have a thickness of between 5 and 700 μm, such as between 8 and 600 μm or between 8 and 500 μm, preferably between 10 and 450 μm.

Preferably, the thickness of the substrate is from 10 to 1000 μm.

Suitably the substrate is selected from a polysulphone substrate, a polyamide substrate and/or a ceramic substrate. The substrate may be selected from a polypropylene substrate, and/or polytetrafluoroethylene substrate and/or a ceramic substrate.

Preferably, the ceramic substrate is selected from one of zeolite, titanium oxide, and zirconia, such as zeolite and zirconia.

The substrate may have a surface roughness, suitably Rz, such as from 0 to 1 μm, such as <500 nm or <300 nm, for example <200 nm or <100 nm, preferably <70 nm or <50 nm, more preferably <30 nm. Advantageously, low surface roughness can provide improved uniformity of the structure in the active layer.

The surface of the substrate operable to receive the active layer may be hydrophilic. Suitably, contact angle of the coating composition on the substrate surface is <90°, such as <70° and preferably <50°.

The substrate may be treated, suitably prior to application of the coating composition, such as with chemical treatment, radiation treatment, plasma treatment and/or thermal treatment, preferably with chemical treatment and/or radiation treatment. Suitably, the substrate is treated over a portion of the surface on which the coating composition is to be contacted.

Advantageously, the treatment of the surface of the substrate can provide enhanced interfacial adhesion and coating layer uniformity to the coating layer, and therefore enhance the membrane's life span, and/or performance, such as selectivity, rejection rate, flux rate during water treatment, and improved uniformity of active layer.

For example, a surface of the substrate operable to receive the coating composition may have been subjected to hydrophilisation. Advantageously, hydrophilisation of the surface can improve wetting characteristics and interfacial adhesion. Said substrate treatment may comprise the addition, suitably the formation, of surface functional groups and/or the addition of hydrophilic additives. The introduced surface functional groups may include one or more of hydroxyl, ketone, aldehyde, carboxylic acid and amine groups. The formation of functional groups may be achieved by one of the following techniques: plasma treatment, redox reaction, radiation, UV-ozone treatment, and/or chemical treatment. Hydrophilic additives may be selected from polyvinyl alcohol, polyethylene glycol, nanofillers, surface modifying macromolecules and zwitterions. The addition of hydrophilic additives may be carried out by coating or depositing additives with desired functionality on the treated membrane surface.

Advantageously, surface treatment of polymeric substrates can provide improved uniformity of the active layer on the substrate for example, by improving the flow and wetting of the surface by the coating material. Surface treatment may also improve the adhesion of active layer on the substrate through improved wetting on the surface by the coating solution, which can further improve separation efficiency and life span. The presence of said hydrophilicity and/or functionality on the polymeric substrate provides an active layer having a more uniform structure, improved continuity, improved adhesion, and enhanced separation efficiency. The said hydrophilicity and/or functionality may also provide extended filter life span and stability to the membrane.

Surface treatment can also improve properties including the antifouling performance of the membrane, enhanced salt rejection and/or enhanced molecule selectivity and/or enhanced permeability. Fouling leads to a decline in flux and useful life-span of a membrane. Fouling can be caused by one or more of the following: organic fouling, biofouling, particulate fouling and colloidal fouling.

For ceramic and metallic substrates, the substrate is preferably not treated.

A coating composition comprising two-dimensional material, i.e. two-dimensional material in at least a partially pre-treated form, may be deposited on the substrate to form the active layer.

The coating composition of any aspect of the present invention may comprise two-dimensional material with a carrier, and/or a metal oxide.

The two-dimensional material may comprise one or more of graphene or derivative thereof, silicene, germanene, stanene, boron-nitride, suitably h-boron nitride, carbon nitride, metal-organic nanosheets, polymer, graphene aerogel, 2D metal-organic frameworks, 3D metal-organic frameworks, and/or transition metal dichalcogenides and derivatives thereof.

Preferably, the two-dimensional material comprises graphene or derivative thereof.

Derivatives of graphene may include any graphene based material such as graphene oxide, reduced graphene oxide from graphene oxide, reduced graphene oxide via bottom-up process, oxidised graphene via treatments from graphite, functionalised graphene, functionalised graphene oxide, functionalised reduced graphene oxide, and/or functionalised oxidised graphene, composites thereof, dispersions thereof.

The above-mentioned two-dimensional materials of the active layer may be produced using any of the suitable methods known to the skilled person. Two-dimensional silicene, germanene and stanene may be produced by surface assisted epitaxial growth under ultrahigh vacuum suction. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by separation. Two-dimensional molybdenum disulfide can be obtained by a few methods, such as mechanical exfoliation, liquid exfoliation and chemical exfoliation. Among these methods, chemical exfoliation has been found to provide high yield. One example is chemical exfoliation using lithium to chemically exfoliate molybdenum disulfide using centrifuge and separation. Two-dimensional tungsten disulfide can be prepared by a deposition-thermal annealing method: vacuum suction or deposition of tungsten and followed by thermal annealing by addition of sulphur. Polymer/graphene aerogel can be produced via coupling and subsequent freeze-drying using polyethylene glycol grafted graphene oxide.

Graphene or derivative thereof may comprise any graphene-based material, such as graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, hydrazide functionalised graphene, hydrazine functionalised graphene, amide functional graphene, amine PEG functionalised graphene, graphene composite, and/or polymer graphene aerogel. Preferably, the graphene or derivative thereof is graphene oxide. Graphene and its derivatives may be obtained commercially from Sigma-Aldrich, and/or any other suitably commercial manufacturers.

The two-dimensional material may be in the form of a monolayer or multi-layer, preferably multi-layer. The two-dimensional material may be formed of particles containing comprise a single, two or multiple layers of two-dimensional material, wherein multiple may be defined as between 3 and 10 layers. Suitably, particles of the two-dimensional material comprises from 1 to 50 layers, such as from 2 to 20 layers or 3 to 10 layers. Suitably, at least 30 wt % of the particles comprise from 1 to 8 layers, such as from 2 to 6 layers or 3 to 5 layers, more preferably at least 40 wt %, 50 wt %, 60 wt %, 70 wt % and most preferably at least 80 wt % or at least 90 wt % or 95 wt % or 98 wt % or 99 wt %. The number of layers in a particle may be measured using Atomic Force Microscopy (AFM or transmission electron microscopy (TEM)) (TT-AFM, AFM workshop Co., CA, USA).

The d-spacing between adjacent lattice planes in the particles of two-dimensional material thereof may be from 0.34 nm to 1000 nm, such as from 0.34 nm to 500 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 20 nm, or from 0.4 to 18 nm, such as from 0.45 to 17 nm, from 0.45 to 16 nm, 0.45 to 15 nm, or 0.45 to 14 nm, for example 0.45 to 10 nm.

The size distribution of the two-dimensional material may be such that at least 30 wt % of the two-dimensional material has a lateral size of between 1 nm to 20,000 nm, such as between 2 to 15,000 nm, Snm to 10,000 nm, 10 nm to 7,500 nm, for example 15 nm to 3,500 nm, 20 nm to 3,000 nm, or 25 nm to 3,000 nm, suitably 30 nm to 2,500 nm, 40 nm to 2,500 nm or preferably 50 nm to 2,500 nm, more preferably at least 40 wt %, 50 wt %, 60 wt %, 70 wt % and most preferably at least 80 wt % or at least 90 wt % or 95 wt % or 98 wt % or 99 wt %. The size of the GO and size distribution may be measured using transmission electron microscopy (TEM, JEM-2100F, JEOL Ltd. Japan).

For example, the lateral size of two-dimensional material may be measured using transmission electron microscopy (TEM, JEM-2100F, JEOL Ltd. Japan), and the number (Nᵢ) of the same sized nanosheets (Mᵢ) measured. The average size may then be calculated by Equation 1:

Average size=Σᵢ₌₁^{∞}NᵢMᵢ/Σᵢ₌₁^{∞}Nᵢ

where Mᵢ is diameter of the nanosheets, and N₁ is the number of the size with diameter Mᵢ.

The atomic oxygen content of the two-dimensional material may be in a range from 1% to 60%, such as 2% to 50%, such as 3% to 45%, or 5% to 44%, or 10% to 44%. Suitably 15% to 44%.

The two-dimensional material may be present in the coating composition in an amount of from 0.0001 wt % to 20 wt % by total weight of the composition (paste), such as 0.0002 wt % to 10 wt %, such as 0.001 to 5 wt %, preferably 0.005 to 1 wt %, such as 0.01 wt % to 0.5 wt %, or from 0.02 wt % to 0.5 wt %.

The carrier may be water, organic solvent or a mixture thereof. Suitably, the carrier is selected from ethanol, propanol, glycol, tertiary butanol, acetone, dimethyl sulfoxide, mixture of dimethyl sulfoxide/alcohol/glycol, water/alcohol/glycol, glycol/water/tertiary butanol, water/acetone mixtures, water/ethanol mixtures, N,N-dimethylformamide, N,N-diethylformamide, dimethylsulfoxide (DMSO), ethylene glycol (EG), N-methyl-2-pyrrolidone, isopropyl alcohol, mineral oil, dimethylformamide, terpineol, ethylene glycol, or mixtures thereof.

Preferably, the carrier is water/ethanol, such as 50/50 vol % water/ethanol, water optionally with one or more stabiliser, such as lithium oxide; N-methyl-2-pyrrolidone (NMP), N,N-dimethylformamide, N,N-diethytformamide or terpineol, most preferably, water:ethanol, such as 50:50 vol % water/ethanol, N,N-dimethylformamide, N,N-diethytformamide. Preferably water.

The composition comprising two-dimensional material having an atomic oxygen content of 530% may further comprise a surfactant, suitably the composition comprises water as a carrier and a surfactant.

The coating composition may contain additives to tailor the properties of the active layer, such as other metals; and/or fibres, such as metal oxide fibres, for example in the form of nanostrands; and/or dopants such as Au, Fe, Cu, Cu(OH)₂, Cd(OH)₂ and/or Zr(OH)₂. Such additives may be added to the membrane to control the pore sizes and channel architecture of two-dimensional material and/or create microchannels or nanochannels for high water flux rate.

Preferably, the composition comprises fibres, suitably in the form of metal oxide nanostrands. Any type of suitable fibres, such as continuous or stapled fibres may be used. The metal oxide nanostrands may be selected from one or more of Cu(OH)₂, Cd(OH)₂ and Zr(OH)₂.

The fibres used to form the nanochannels may have a diameter of from 0.1 to 1000 nm. Such as a diameter of from 0.1 to 850 nm, 0.2 to 750 nm, 0.3 to 500 nm, or 0.4 to 250 nm, or 0.45 to 150 nm, or 0.45 to 100 nm, 0.45 to 75 nm, preferably, 0.45 to 50 nm or 0.45 to 10 nm, preferably 0.45 to 5 nm.

The length of the fibres may be in a range of from inm to 100 μm, such as 2 nm to 75 μm, or 3 nm to 50 μm, for example 100 nm to 15 μm or 500 nm to 10 μm.

The length of the fibres when the coating composition is for applicable by printing may range from 2 nm to 10 μm. Preferably, from 100 nm to 10 μm, preferably from 200 nm to 10 μm. When the length is too long, it may cause the blockage to the nozzle, and when the length is too short, only caves may be generated.

The fibres may be present in the coating composition in a concentration of from 0.01% to 150% of the two-dimensional material concentration, such as from 0.01% to 100%, 0.01% to 50%, 0.01% to 20%, preferably 0.01% to 10%.

The concentration of fibres in the coating composition may be from 0.0001 mg/ml to 10 mg/ml, such as from 0.0005 mg/ml to 9 mg/ml, 0.001 mg/ml to 8 mg/ml, such as from 0.005 mg/ml to 7 mg/ml, 0.007 mg/ml to 6 mg/ml, such as from 0.008 mg/ml to 5.5 mg/ml, 0.009 mg/ml to 5 mg/ml, such as from 0.01 mg/ml to 4.5 mg/ml, 0.02 mg/ml to 4 mg/ml, such as from 0.03 mg/ml to 3.5 mg/ml, 0.04 mg/ml to 3 mg/ml, such as from 0.05 mg/ml to 2.5 mg/ml.

Suitably, the fibres are removed before use, such as by mechanical removal or by dissolution, etc. For example, after the coating composition has been applied to the substrate, the fibres may be removed, for example by dissolving using an acid, for example an acid having a pH of from 1 to 6, preferably ethylenediaminetetraacetic acid, such as by immersing the membrane in an acidic solution, for example 0.15 M EDTA aqueous solution, suitably, for 20 min, optionally followed by washing with deionised water repeatedly. Advantageously, the use of fibres, such as metal oxide nanostrands, can significantly improve the water flux rate of the membrane whilst maintaining a similar salt/molecule rejection rate.

The coating composition of any aspect of the present invention may be prepared by dispersing or dissolving one or more components in the carrier or solvent using one or a combination of mechanical mixing, e.g. leading edge-trailing blade stirring, ceramic ball grinding and milling, mechanical mixing using Silverson high shear mixer, glass bead mechanical milling, e.g. in an Eiger Torrance motormill, Ultra Turrax homogeniser, mortar and pestle grinding, mechanical roll milling, sonication, untrasonication. The fibres may be mixed with the coating composition by sonication or mechanical blending in dispersion.

Centrifuge may be used to filter out ingredient aggregation or large size ingredient in the coating composition.

Pre-separation of the coating composition may be used to control the ingredient size and size distribution for the desired coating method. For example, the coating composition may be passed through a 0.45 um polymer membrane to form an ink which is for an inkjet printer with nozzle size of 20 um.

The method according to any aspect of the present invention may comprise coating the coating composition onto the substrate using gravity deposition, vacuum suction or suction or deposition, dip coating, pressure deposition, printing, preferably digital printing, such as inkjet printing, aerosol printing, 3D printing, offset lithography printing, gravure printing, flexographic printing techniques, pad printing, bar coating, curtain coating, dip coating, spin coating, screen coating, gravure coating and other printing or coating techniques known to those skilled in the art.

Preferably the coating composition is coated onto the substrate using bar coating, flexo-coating, ink-jet printing, screen coating or slot coating.

The method of inkjet printing may be drop on demand (DOD) inkjet printing, for example piezoelectric or thermal; or continuous inkjet printing (CIJ), preferably the inkjet printing is DOD inkjet printing.

The cartridge drop volume may be from 1 pl to 1000 pl or 1 pl to 500 pl, or 2 pl to 250 pl, or 3 pl to 100 pl, suitably from 5 to 50 pl, or from 8 to 30 pl, such as 10 pl. The voltage and firing frequency of the inkjet printing method may depend on the waveform of the coating composition. The firing voltage may be from 10 to 50 V. The firing frequency may be from 3 kHz to 30 kHz, suitably about 5 kHz. The cartridge temperature of the inkjet printer may be from 10° C. to 50° C., suitably about 20° C. to 40° C. The stage temperature of the inkjet printer may be from 20° C. to 60° C., suitably about 21° C.

The coating speed is dependent on the coating application method. For an example, the coating speed for inkjet printing or flexo-printing or mayor bar coating may be from 0.01 m/s to 500 m/s, such as from 0.03 m/s to 450 m/s, from 0.05 m/s to 400 m/s, from 0.08 m/s to 350 m/s, such as from 0.1 m/s to 300 m/s, from 0.12 m/s to 250 m/s, from 0.15 m/s to 200 m/s, from 0.17 m/s to 150 m/s, such as from 0.2 m/s to 100 m/s, from 0.4 m/s to 70 m/s, such as from 0.5 m/s to 60 m/s, from 0.7 m/s to 50 m/s, from 0.8 m/s to 40 m/s, from 0.9 m/s to 30 m/s, such as 1 m/s to 20 m/s.

The viscosity of the coating composition for vacuum suction or deposition may be from 0.1 to 8000 cPa, such as 0.5 to 7000 cPa, or 0.5 to 6000 cPa, or 0.5 to 5000 cPa, such as 0.5 to 4000 cPa, or 0.75 to 3000 cPa, such as 0.75 to 2000 cPa, or 0.75 to 1000 cPa, or 0.75 to 800 cPa, such as 1 to 700 cPa, or 1 to 600 cPa, preferably 1 to 500 cPa, or 1 to 250 cPa, 1 to 200 cPa, 1 to 100 cPA or 2 to 80 cPa.

The surface tension of the coating composition may be from 1 to 1000 mN/m, such as from 2 to 900 mN/m, or 3 to 800 mN/m, such as 4 to 700 mN/m, or 5 to 600 mN/m, or 6 to 500, preferably 8 to 400 mN/m or 9 to 300 mN/m, more preferably 10 to 200 mN/m or 15 to 150 mN/m or 25 to 100 mN/m.

The coating composition may be applied to the substrate such that the active layer is formed of one or a multiple coating layers by repeating the coating process or using multicoating processes.

The coating layer may be coated from one or more of the same or different coating compositions.

The active layer may comprise multiple coating layers, wherein at least one of the layers was treated before deposition of a subsequent layer. Preferably, each layer was treated before deposition of the subsequent layer. The layers of active layer comprising multiple coating layers may have been subjected to different treatments, in terms of the type of treatment and/or the extent of the treatment. As such, at least one of the layers may comprise two-dimensional material having different functionality to another layer. For example, the layers may comprise a gradient of decreasing reduction level in the two-dimensional material from the top of the active layer towards the bottom of the active layer adjacent to the substrate. The gradient may be created in the reverse direction.

The presence of the gradient may increase the adhesion between the active layer and substrate, and may also increase the fouling resistance of the overall membrane.

The gradient may be linear or varied, for example the level of treatment may increase or decrease first, and then decrease or increase again, and in a regular or irregular pattern.

A varied gradient may increase the fouling resistance of the overall membrane. A varied gradient may also enable selective sieving of molecules.

### Treatment of the Two-Dimensional Material

Treatment of the two-dimensional material on the substrate may cause a change in the functional groups of the two-dimensional material, for example changed the number, species and/or distribution of the functional groups. For example, treatment may reduce the two-dimensional material and/or may functionalise the two-dimensional material by the adding functionality to the two-dimensional material.

Treatment of the two-dimensional material thereof to functionalise the two-dimensional material may add or change the functional groups of the two-dimensional material, for example by reaction with existing hydroxyl, carboxylic and/or epoxide groups of the two-dimensional material. Functionalisation includes covalent modification and non-covalent modification. Covalent modification method can be subcategorised to nucleophilic substitution reaction, electrophilic substitution reaction, condensation reaction, and addition reaction.

The two-dimensional material may be treated, suitably reduced, by exposing the two-dimensional material to radiation, such as laser radiation, microwave radiation, UV radiation, E-beam radiation, plasma treatment, electron radiation, soft X-ray radiation, gamma radiation, alpha radiation; chemical treatment and/or thermal treatment. Preferably, laser radiation and plasma treatment.

Chemical, thermal or radiation treatment of the two-dimensional material on the substrate can be used to form chemically reduced GO (CRGO), thermally reduced graphene oxide (TRGO) or radiation reduced graphene oxide (RRGO).

The laser sources used to treat the two-dimensional material with laser radiation may be selected from gas lasers, paramagnetic ions, chemical lasers, metal vapour lasers, dye lasers, free electron laser, gas dynamic laser, Raman laser, nuclear pumped laser, semiconductor lasers, solid-state lasers, such as nitrogen laser, helium-neon laser, argon laser, krypton laser xenon ion laser, carbon dioxide laser, carbon monoxide laser, excimer laser, such as hydrogen fluoride laser, deuterium laser, chemical oxygen-iodine laser, all gas-phase iodine laser, such as stilbene laser, coumarin laser, rhodamine laser, such as helium-cadmium laser, helium-mercury laser, helium-selenium laser, helium-silver laser, strontium vapor laser, neon-copper laser, copper vapor laser, gold vapor laser, gold vapor laser, manganese laser, such as ruby laser, Nd:YAG laser, NdCrYAG laser, Er:YAG laser, Neodymium YLF solid-state laser, neodymium doped Yttrium orthovanadate laser, neodymium doped yttrium calcium oxoborate Nd:YCa4O(BO3)3 laser, neodymium glass laser, titanium sapphire laser, thulium laser, Ytterbium laser, Ytterbium doped glass laser, holmium YAG laser, chromium ZnSe laser, cerium doped lithium strontium (or calcium aluminium fluoride laser), promethium 147 doped phosphate glass laser, chromium doped chrysoberyl laser, erbium doped and erbium-ytterbium, trivalent uranium doped calcium fluoride solid-state laser, divalent samarium doped calcium fluoride laser, F-centre laser, such as semiconductor laser diode laser, GaN laser, InGaN laser, AiGalnP laser, AlGaAs laser, lead salt laser, vertical cavity surface emitting laser, quantum cascade laser, hybrid silicon laser. Preferably gas lasers, paramagnetic ions, chemical lasers, metal vapour lasers, dye lasers, or free electron laser.

The wavelength of the laser radiation may be from 150 nm to 360,000 nm, such as 150 nm to 300,000 nm, 155 nm to 250,000 nm, such as 150 nm to 200,000 nm, such as 162 nm to 150,000 nm, such as 165 nm to 100,000 nm, such as 166 nm to 80,000 nm, 170 nm to 60,000 nm, such as 175 nm to 45,000 nm, such as 176 nm to 35,000 nm, such as 177 nm to 25,000 nm, such as 178 nm to 20,000 nm, 179 nm to 15,000 nm, 180 nm to 10,000 nm, 182 nm to 5,000 nm, 183 nm to 3,500 nm, such as 185 nm to 3,000 nm, 188 nm to 2,000 nm, 189 nm to 1,000 nm, such as 190 nm to 900 nm, or 192 nm to 650 nm.

The intensity of the laser radiation may be in a range from 1×10⁵ W/cm² to 1×10²⁹ W/cm², such as 5×10⁵ W/cm² and 1×10²⁸ W/cm², 1×10⁶ W/cm² and 1×10²⁷ W/cm², 1×10⁶ W/cm² and 1×10²⁶ W/cm², such as 5×10⁶ W/cm² and 1×10²⁵ W/cm², 1×10⁷ W/cm² and 1×10²⁴ W/cm², 5×10⁷ W/cm² and 1×10²³ W/cm², such as 1×10⁸ W/cm² and 1×10²² W/cm², 5×10⁸ W/cm² and 1×10²¹ W/cm², such as 1×10⁹ W/cm² and 1×10²⁰ W/cm².

The laser scanned number may be from 1 and 1000, such as 1 and 900, 1 and 800, 1 and 700, 1 and 600, 1 and 500, 1 and 400, 1 and 300, 1 and 200, 1 and 100, 1 and 90, 1 and 80, 1 and 70, 1 and 60, 1 and 50, 1 and 40, 1 and 35, 1 and 30, such as 1 and 25, 1 and 20, such as 1 and 15.

The laser scanning speed may be from 0.1 mm/s to 1000 mm/s, such as from 0.5 mm/s to 900 mm/s, from 1 mm/s to 850 mm/s, from 1.5 mm/s to 800 mm/s, from 2 mm/s to 750 mm/s, from 2.5 mm/s to 700 mm/s, such as from 3 mm/s to 650 mm/s, from 5 mm/s to 600 mm/s, from 6 mm/s to 550 mm/s, such as from 7 mm/s to 500 mm/s, from 8 mm/s to 450 mm/s, from 8.5 mm/s to 400 mm/s, such as from 9 mm/s to 350 mm/s, from 10 mm to 300 mm/s, such as from 11 mm/s to 250 mm/s.

The laser energy density (fluence) may be from 0.001 J/cm² to 100 J/cm², such as from 0.003 J/cm² to 90 J/cm², from 0.005 J/cm² to 85 J/cm², from 0.007 J/cm² to 80 J/cm², from 0.01 J/cm² to 75 J/cm², from 0.02 J/cm² to 70 J/cm², from 0.03 J/cm² to 65 J/cm², such as from 0.04 J/cm² to 60 J/cm², from 0.05 J/cm² to 55 J/cm², from 0.055 J/cm² to 50 J/cm², such as from 0.06 J/cm² to 45 J/cm², from 0.065 J/cm² to 40 J/cm², such as from 0.07 J/cm² to 35 J/cm² or from 0.07 to 30 J/cm².

The pulse length of the laser radiation may be from femtosecond to nanosecond to microsecond to continuous waves.

The laser beam diameter or width may be in a range of 0.1 nm and 1 cm, such as 0.5 nm and 0.7 cm, 1 nm and 0.5 cm, 5 nm and 0.2 cm, such as 10 nm and 0.1 cm, 15 nm and 500 um, 16 nm and 700 um, 17 nm and 100 um, 18 nm and 80 um, such as 20 nm and 15 um.

Laser radiation may be carried out in ambient atmosphere or vacuum suction or atmosphere, or inert gas atmosphere, such as nitrogen, helium, argon or carbon dioxide.

The two-dimensional material on the substrate may be subjected to chemical treatment, suitably to reduce the two-dimensional material.

A solution of a reductant may be used to reduce the two-dimensional material on the substrate. The chemical solution may comprise a treatment agent, suitably selected from H₂O₂, NaOH and/or hydrazine (N₂H₄), ascorbic acid, sodium bicarbonate, sodium borohydride, sodium borohydrate, hydrochloric acid, melatonine, polyphenol, vitamin C, hydriodic acid, trifluoroacetic acid, sulfur-containing compounds such as Na₂SO₃, NaHSO₃, NaS₂O₃, Na₂S₉H₂O, SOCl₂, and SO₂, preferably hydrazine, sodium borohydride and/or ascorbic acid.

The concentration of the treatment agent in the solution is dependent on the treatment agent selected. For example, the amount of the treatment agent, such as of H₂O₂, NaOH and/or N₂H₄, in water may be in a range from 0.01 wt. % to 90 wt. % by total weight of the solution, such as from 0.05 wt. % to 85 wt. %, from 0.09 wt. % to 80 wt. %, from 0.1 wt. % to 75 wt. %, such as from 0.5 wt. % to 70 wt. % from 0.9 wt. % to 65 wt. %, from 1 wt. % to 60 wt. %, from 1.5 wt. % to 55 wt. %, from 1.7 wt. % to 50 wt. %, such as from 2 wt. % to 45 wt. %, from 2.5 wt. % to 40 wt. %, from 2.7 wt. % to 35 wt. %, such as from 3 wt. % to 30 wt. %.

The treatment agent may be added to the coating composition prior to application of the composition to the substrate.

The temperature for treatment may be 0-200° C., such as 10 to 150° C., such as 15 to 120° C., or 16 to 110° C., such as 17 to 100° C., such as 18 to 90° C., preferably from 19 to 90° C.

Suitably, treatment of the two-dimensional material comprises passing the treatment agent through the membrane and/or the membrane may be impregnated with the treatment agent.

Treatment may comprise or consist of thermal treatment applied to the coating composition, such as hydrothermally, or to treatment of the membrane post coating. Thermal treatment may be applied under an inert atmosphere such as nitrogen and/or at temperatures of at least at 80° C., such as at least 100° C., such as from 100° C. to 800° C., such as 100° C. to 700° C., 100° C. to 500° C., 100° C. to 400° C., 100° C. to 500° C., preferably 100° C. to 450° C.

Advantageously, the treated membrane may provide improved performance, such as improved selective sieving, improved size exclusion, improved rejection rate, such as improved ion rejection, compound rejection, oil rejection, bacteria rejection, virus rejection, cyst rejection, such as improved flux rate.

The features of the treated two-dimensional material may be according to any one or more of the features as defined above in relation to the two-dimensional materials of the coating composition, i.e. of the two-dimensional material in a pre-treated form. For example, with regard to the types of two-dimensional material, the form of the two-dimensional material, the d-spacing of the two-dimensional material, the size distribution of the two-dimensional material, and/or the atomic content of the two-dimensional material.

Advantageously, the treated membrane can be tailored to the desired hydrophilicity, and/or to enhance the electrical and/or thermal conductivity of the membrane.

The hydrophilicity of treated membrane may be controlled by the functional groups or polar atom percentage, such as oxygen or nitrogen left at the surface after treatment.

The hydrophilicity can be empirically quantified by calculating the number of functional groups remaining on the treated two-dimensional material, or by measuring the polar atom percentage, such as oxygen or nitrogen, according to methods known to the skilled person using X-ray photoelectron spectroscopy.

The atomic oxygen or nitrogen content of the two-dimensional material, suitably of a laser treated two-dimensional material, may be from 0% to 65%, such as 0.5% to 50%, 0.8% to 48%, 1% to 49%, 1.2% to 46%, 1.5% to 45%, such as 1.8% to 44%, 2.0% to 44%, 2.2% to 44%, 2.2% to 43%, such as 2.5% to 43%, 3.0% to 43%, such as 3.5% to 43% or 10 to 43%.

The treated two-dimensional material thereof may have a thermal conductivity in a range of from 0.1 W/mK to 6,000 W/mK, such as 1 W/mK to 5,500 W/mK, 1.5 W/mK to 5,000 W/mK, such as 2 W/mK to 4,500 W/mK, 2.5 W/mK to 4,100 W/mK, 3 W/mK to 3,800 W/mK, such as 3.5 W/mK to 3,300 W/mK, 4 W/mK to 3,000 W/mK, such as 4.5 W/mK to 2,500 W/mK, 5 W/mK to 2,000 W/mK, 5.5 W/mK to 1,700 W/mK, such as 6 W/mK to 1,500 W/mK, 6.5 W/mK to 1,300 W/mK, 7 W/mK to 1,100 W/mK, 8 W/mK to 900 W/mK, 9 W/mK to 800 W/mK.

The treated two-dimensional material preferably has a thermal conductivity of from 9 W/mK to 800 W/mK.

The treated two-dimensional material may have an electrical conductivity of in a range of from 1×10⁻⁶ S/m to 600,000 S/m, such as 5×10⁻⁶ S/m atond 300,000 S/m, 8×10⁻⁶ S/m to 100,000 S/m, 1×10⁻⁵ S/m to 50,000 S/m, such as 3×10⁻⁵ S/m to 28,000 S/m, 8×10⁻⁵ S/m to 25,000 S/m, 1×10⁻⁴ S/m to 24,000 S/m, such as 3×10⁻⁴ S/m to 23,000 S/m, 5×10⁻⁴ S/m to 20,000 S/m, 1×10⁻³ S/m to 17,000 S/m, 5×10⁻⁴ S/m to 14,000 S/m, such as 1×10⁻² S/m to 10,000 S/m, 5×10⁻² S/m to 8,000 S/m, such as 0.1 S/m to 7,000 S/m, 1 S/m to 6,000 S/m.

Suitably, the treated functionalised two-dimensional material comprises a higher number of at least one type of functional group than prior to treatment of the two-dimensional material. The functionalised treated two-dimensional material thereof may comprise amino groups; aliphatic amino groups, such as long-chain (e.g. C₁₆ to C₅₀) aliphatic amino groups; porphyrin-functionalised secondary amino groups, and/or 3-amino-propyltrialkoxysilane groups such as 3-amino-propyltriethoxysilane groups. Preferably the amino functionalised treated two-dimensional material is amino functionalised treated graphene oxide. Such functionalisation can provide for the improved selective sieving of ferric acid. The functionalised treated two-dimensional material may be formed from treatment of graphene oxide (GO) utilizing existing —COOH, —OH, and C—O—C groups.

The functionalised treated graphene or derivative thereof may be: amino-based graphene (such as due to addition of CONH(CH₂)NH₂, NH₂-TTP, alkylamine functionalised GO, and/or ammonia functionalised graphene oxide), isocyanate modified GO, (such as —CO—NHR group), octadecylamine functionalised reduced graphene oxide, polymer graphene aerogel, azide-, alkyne-functionalised GO, poly(allylamine) modified, DNA or protein modified (non-covalent). The functionalised treated graphene or derivative thereof may comprise functional groups attached toward the edge of the two-dimensional material, such as NO₂, —NH₂, —SO₃H, halide, —N₃, —MgBr and/or —SH groups. Suitably the functionalised treated graphene or derivative thereof comprises a higher number of such groups toward the edge of the platelets compared to the untreated graphene or derivative thereof. The active layer may comprise a functionalised reduced graphene oxide with restoration of pi-pi interactions resulting in non-covalent bonding to polymers, such as polystyrene and/or polyether sulphone and/or to small molecules such as pyrene and derivatives, tetracyanoquinodimenthane, perylene derivatives and/or other aromatic species.

The thickness of the active layer may be at least 0.5 nm, such as at least 0.7 nm or at least 0.9 nm. The active layer may have a thickness of from 1 nm to 8000 nm, such as from 2 to 5000 nm or from 3 to 4000 nm, such as 4 to 3000 nm or 5 to 2000 nm, or 5 to 1000 nm, or 10 to 500 nm, such as 10 to 400 nm, or 10 to 200 nm, preferably 10 to 100 nm or 5 to 60 nm.

Preferably, the active layer is substantially formed from two-dimensional material, suitably of graphene or derivative thereof, more preferably treated graphene or derivative thereof.

The amount of two-dimensional material in the active layer or each coating layer may be at least 1 wt %, or at least Swt %, such as from 5 to 100 wt %, such as 10 to 100 wt %, 15 to 99 wt %, 20 to 99.9 wt %, 20 to 99.8 wt %, 50 to 99.7 wt %, 80 to 99.7 wt %, preferably from 85 to 99.7 wt %.

The active layer may comprise additives to tailor the properties of the active layer, such as other metals and/or fibres, such as metal oxide fibres, for example nanostrands and/or dopants, e.g. Au, Fe, Cu, Cu(OH)₂, Cd(OH)₂ and Zr(OH)₂. Such additives may affect the interlayer distance and/or create microchannels or nanochannels for high water flux rate.

The active layer may further comprise microchannels or nanochannels, suitably formed by the use and subsequent removal of fibres in the production of the membrane and/or by treatment of the two-dimensional material. Advantageously the presence of microchannels and/or nanochannels within the active layer has been found to significantly increase the water flux and enhance the membrane's fouling resistance properties.

The treated portion of the two-dimensional material thereof may be the whole of the two-dimensional material or part of the two-dimensional material. For example, the active layer may comprise two-dimensional material that has been treated on the surface of at least one coating layer, on the surface of the active layer, through at least one coating layer, and/or through the whole active layer. Partial treatment of the two-dimensional material may be used to form channels, for examples microchannels or nanochannels, which may be in the form of closed or open loops, patterns of electronic circuits, a grid and/or artistic patterns.

The nanochannels or microchannels may have a diameter of from 0.1 to 1000 nm. Such as a diameter of from 0.1 to 850 nm, 0.2 to 750 nm, 0.3 to 500 nm, or 0.4 to 250 nm, or 0.45 to 150 nm, or 0.45 to 100 nm, 0.45 to 75 nm, preferably, 0.45 to 50 nm or 0.45 to 10 nm, preferably 0.45 to 5 nm.

The presence of nanochannels may increase flux rate by at least 50%, such as 100%, or 150%, or 500%, or 1000% compared to an active layer that does not include nanochannels.

The presence of microchannels and/or nanochannels in the active layer can provide functionality such as electrical conductivity, and/or thermal conductivity which can be used to monitor the life span or failure of the membranes. For an example, the failure of a membrane may be detectable by damage to the electrical conductive channels, resulting in the change of voltage or current intensity at that part of the channel.

The thickness of the active layer deposited on the substrate with deposition may be controlled by the concentration of the composition at a fixed volume, for example 100 ml of 0.001 mg/ml.

The membrane of the present invention may be for any type of separation. Suitably the membrane is for water separation, such as desalination or oil and water separation, or for chemical separation.

Chloride can be harmful to polymeric substrates, the coated membrane may sieve chloride and reduce the contact between chloride and polymeric substrate, which may prolong the life span of the substrate.

The term “lamellar structure” when used herein means a structure having at least two overlapping layers. The term “active layer” when used herein means a layer operable to provide separation across the layer. The term “two-dimensional material” when used herein means a material with at least one dimension of less than 100 nm.

The term aliphatic herein means a hydrocarbon moiety that may be straight chain, branched or cyclic, and may be completely saturated, or contain one or more units of unsaturation, but which is not aromatic. The term “unsaturated” means a moiety that has one or more double and/or triple bonds. The term “aliphatic” is therefore intended to encompass alkyl, alicyclic, alkenyl or alkynyl groups. An aliphatic group preferably contains 1 to 15 carbon atoms, such as 1 to 14 carbon atoms, 1 to 13 carbon atoms, that is, an aliphatic group with 1, 2, 3, 4, 5, 6, 7, 8, 9, 10, 11, 12, 13 carbon atoms.

An alkyl group contains 1 to 15 carbon atoms. Alkyl groups may be straight or branched chained. The alkyl group preferably contains 1 to 14 carbon atoms, 1 to 13 carbon atoms, that is, an alkyl group with 1, 2, 3, 4, 5, 6, 7, 8, 9, 10, 11, 12, 13 carbon atoms. Specifically, examples of an alkyl group include methyl, ethyl, n-propyl, iso-propyl, n-butyl, iso-butyl, sec-butyl, tert-butyl, n-pentyl, n-hexyl, n-heptyl, n-octyl, n-nonyl, n-decyl, n-undecyl, n-dodecyl, n-tridecyl, n-tetradecyl, n-pentadecyl, 1,1-dimethylpropyl, 1,2-dimethylpropyl, 2,2-dimethylpropyl, 1-ethylpropyl, n-hexyl, 1-ethyl-2-methylpropyl, 1,1,2-trimethylpropyl, 1-ethylbutyl, 1-methylbutyl, 2-methylbutyl, 1,1-dimethylbutyl, 1,2-dimethylbutyl, 2,2-dimethylbutyl, 1,3-dimethylbutyl, 2,3-dimethylbutyl, 2-ethylbutyl, 2-methylpentyl, 3-methylpentyl and the like, and isomers thereof.

Alkenyl and alkynyl groups each contain 2 to 12 carbon atoms, such as 2 to 11 carbon atoms, 2 to 10 carbons atoms, such as 2 to 9, 2 to 8 or 2 to 7 carbon atoms. Such groups may also contain more than one carbon-carbon unsaturated bond.

Alicyclic groups may be saturated or partially unsaturated cyclic aliphatic monocyclic or polycyclic (including fused, bridging and spiro-fused) groups which have from 3 to 15 carbon atoms, such as 3 to 14 carbon atoms or 3 to 13 carbon atoms, that is an alicyclic group with 3, 4, 5, 6, 7, 8, 9, 10, 11, 12, 13 carbon atoms. Preferably, an alicyclic group has from 3 to 12, more preferably from 3 to 11, even more preferably from 3 to 10, even more preferably from 3 to 9 carbon atoms, or from 3 to 8 carbons atoms or from 3 to 7 or 3 to 6 carbon atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of C₃₋₁₅ cycloalkyl groups include cyclopropyl, cyclobutyl, cyclopentyl, cyclohexyl, cycloheptyl, adamantyl, isobornyl and cyclooctyl.

An aryl group is a monocyclic or polycyclic group having from 6 to 14 carbon atoms, such as 6 to 13 carbon atoms, 6 to 12, or 6 to 11 carbon atoms. An aryl group is preferably a “C₆₋₁₂ aryl group” and is an aryl group constituted by 6, 7, 8, 9, or 10 carbon atoms and includes condensed ring groups such as monocyclic ring group, or bicyclic ring group and the like. Specifically, examples of “C₆₋₁₀ aryl group” include phenyl, biphenyl, indenyl, naphthyl or azulenyl and the like. It should be noted that condensed rings such as indan and tetrahydro naphthalene are also included in the aryl group.

The use of the term “hetero” in heteroaliphatic and heteroaryl is well known in the art. Heteroaliphatic and heteroaryl refers to an aliphatic or aryl group, as defined herein, wherein one or more carbon atoms has been replaced by a heteroatom in the chain and/or ring of the group, as applicable, respectively. The heteroatom(s) may be one or more of sulphur and/or oxygen.

The heteroatom(s) may be in any form that does not remove the ability of the amine groups of the multifunctional amine to react with the multifunctional amine-reactive. The heteroatom(s) may be in the form of an ether group, such as C₁-C₁₅ alkoxy; if terminal, a hydroxyl group; sulphur and oxygen heterocycles; and/or a polysulphide group, such as a polysulphide containing at least two sulphur atoms.

Preferably, the alkoxy group contains from 1 to 8 carbon atoms, and is suitably selected from methoxy, ethoxy, propoxy, butoxy, pentlyoxy, hexyloxy, heptyloxy, octyloxy, and isomeric forms thereof.

As used herein, unless otherwise expressly specified, all numbers such as those expressing values, ranges, amounts or percentages may be read as if prefaced by the word “about”, even if the term does not expressly appear. “About” may be defined as +/−10% of the stated value. Also, any numerical range recited herein is intended to include all sub-ranges subsumed therein. Singular encompasses plural and vice versa. For example, although reference is made herein to “a” substrate, “an” active layer, “a” coating composition, “a” two-dimensional material and the like, one or more of each of these and any other components can be used. As used herein, the term “polymer” refers to oligomers and both homopolymers and copolymers, and the prefix “poly” refers to two or more. Including, for example and like terms means including for example but not limited to. Additionally, although the present invention has been described in terms of “comprising”, the processes, materials, and aqueous coating compositions detailed herein may also be described as “consisting essentially of” or “consisting of”.

All of the features contained herein may be combined with any of the above aspects in any combination.

For a better understanding of the invention, and to show how embodiments of the same may be carried into effect, reference will now be made, by way of example, to the following examples.

### EXAMPLES

### Example 1—Preparation of Reduced Graphene Oxide Membrane Via Multilayer Coating Using Different Graphene-Based Materials

An ink containing 1 mg/ml graphene oxide with atomic oxygen content of 40% was coated to a polysulfone substrate with pore size of 25 nm using flexo coating technique, and the coating thickness was about 20 nm. Following drying under ambient conditions, another ink containing 1 mg/ml reduced graphene oxide with atomic oxygen content of 10% was coated to the surface of coated graphene oxide from above, using flexo coating, and the coating thickness was about 20 nm. The performance of the resultant membrane was then assessed and found to exhibit improvement of life span by 100% and dye molecules rejection rate by 50% compared to reduced graphene oxide only coating.

### Example 2—Preparation of Reduced Graphene Oxide Membrane with Substrate Treatment and Different Graphene-Based Materials

A polysulfone substrate with pore size of 25 nm was soaked in 0.25 M NaOH for 20 min and then washed by deionised water and dried at 40° C. for 1 hour. An ink containing 1 mg/ml graphene oxide with atomic oxygen content of 40% was then coated to the substrate using flexo coating technique, and the coating thickness is about 20 nm. Following drying under ambient conditions, another ink containing 1 mg/ml reduced graphene oxide with atomic oxygen content of 10% was coated to the surface of coated graphene oxide from above, using flexo coating, and the coating thickness is about 20 nm. The performance of the resultant membrane was then assessed and found to exhibit improvement of life span by 200% and dye molecules rejection rate by 50% compared to reduced graphene oxide only coating.

### Example 3—Preparation of Reduced Graphene Oxide Membrane with Post Treatment Method

A polysulfone substrate with pore size of 25 nm was soaked in 0.25 M NaOH for 20 min and then washed by deionised water and dried at 40° C. for 1 hour. An ink containing 1 mg/ml graphene oxide with atomic oxygen content of 40% was then coated to the substrate using flexo coating technique, and the coating thickness is about 40 nm. Following drying under ambient conditions, the coated surface was then soaked in 0.1 M sodium borohydrate water solution for 0.5 hour. The performance of the resultant membrane was then assessed and found to exhibit dye molecules rejection by 60% compared to 0% of uncoated substrate.

### Example 4—Preparation of a Separation Membrane by Post Treatment

A polysulfone substrate with pore size of 25 nm was soaked in 0.25 M NaOH for 20 min and then washed by deionised water and dried at 40° C. for 1 hour. An ink containing 1 mg/ml graphene oxide with atomic oxygen content of 40% mixed with 0.5 mg/ml Cu(OH)₂ nanostrands with diameter of 2 nm and length of 1 um, was then coated to the substrate using flexo coating technique, and the coating thickness was about 100 nm. Following drying under ambient conditions, the coated surface was then soaked in 0.1 M sodium borohydrate water solution for 0.5 hour to reduce graphene oxide, and filtered with 0.15 M ethylenediaminetetraacetic acid to dissolve nanostrands and create nanochannels. The performance of the resultant membrane was then assessed and found to exhibit an significant improvement of flux rate of at least 300% and dye molecules rejection rate of 40% in comparison to graphene oxide coated membrane.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A separation membrane comprising a porous substrate layer and an active layer arranged over at least a part of the substrate layer, wherein the active layer comprises a lamellar structure comprising at least two layers of treated two-dimensional material.

2. A method of producing a separation membrane according to claim 1, the method comprising the steps of:
a. optionally preparing a substrate, optionally by treating the substrate with chemical treatment and/or radiation treatment, and/or plasma treatment, and/or thermal treatment;
b. contacting the substrate with a composition comprising a two-dimensional material, optionally by forming a first layer of the composition comprising a two-dimensional material and then applying a further layer of the composition comprising a two-dimensional material to the first layer; a layer may optionally be dried before application of the subsequent layer;
c. optionally, drying the membrane.
d. treating the two-dimensional material applied in step (b) to cause a change to the functional groups of the two-dimensional material, such as by application of high energy radiation such as laser radiation, chemicals, heat, thermal heat and/or pressure to the two-dimensional material; optionally by treating a first layer of the composition before application and subsequent treatment of a further layer of the composition;
e. optionally, drying the membrane.

3. The membrane according to claim 1, wherein at least one of the coating layers of the active layer is different to another coating layer of the active layer.

4. The method according to claim 2,
wherein at least one of coating layer is different to another coating layer.

5. The membrane according to claim 1, wherein the active layer comprises nanochannels having a diameter of from 1 to 100 nm

6. A method of producing a separation membrane of claim 1, the method comprising the steps of:
a. optionally preparing a substrate
b. contacting the substrate with a coating composition comprising two-dimensional material and nanofibres;
c. removing the nanofibres by contacting the membrane produced by step (b) with mild acid, such as an acid having a pH of from 1 to 6;
d. treating, and preferably reducing, the two-dimensional material, preferably by laser treatment, chemical treatment, and/or thermal treatment;
e. optionally, drying the membrane.

7. The membrane according to claim 1, wherein the substrate comprises a polymeric substrate, a polymeric substrate containing inorganic filler, a ceramic substrate, a composite substrate, a metal substrate, an inorganic substrate, inorganic-organic substrate, woven filament, and/or non-woven, and/or a casted substrate.

8. The membrane according to claim 1, wherein the substrate is in the form of a porous film, porous plate, porous hollow fibre substrate, tubular fibre substrate, or a bulky porous material.

9. The membrane according to claim 1, wherein the polymeric substrate is selected from one or more of polyamide (PA), polysulphone (PSf), polyvinylidene fluoride (PVDF), and thin film composite (TFC), such as polysulphone supported polyamide composite substrate.

10. The membrane according to claim 1, wherein the average size of the pores of the substrate may be from 0.1 nm to 30,000.

11. The membrane according to claim 1, wherein the active layer is formed from a coating composition comprising the two-dimensional material.

12. The membrane according to claim 11, wherein the coating composition comprises two-dimensional material with a carrier and/or an additive.

13. The membrane according to claim 1, wherein the two-dimensional material comprises one or more of graphene or derivative thereof, silicene, germanene, stanene, boron-nitride, carbon nitride, metal-organic nanosheets, polymer, graphene aerogel, 2D metal-organic frameworks, 3D metal-organic frameworks, and/or transition metal dichalcogenides and derivatives thereof.

14. The membrane according to claim 1, wherein the two-dimensional material comprises graphene or derivative thereof.

15. The membrane according to claim 14, wherein the graphene or derivative thereof is selected from one or more of graphene oxide, reduced graphene oxide from graphene oxide, reduced graphene oxide via bottom-up process, oxidised graphene via treatments from graphite, functionalised graphene, functionalised graphene oxide, functionalised reduced graphene oxide, and/or functionalised oxidised graphene, composites thereof, dispersions thereof.

16. The membrane according to claim 14, wherein the graphene or derivative thereof is selected from one or more graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide, hydrazide functionalised graphene, hydrazine functionalised graphene, amide functional graphene, amine PEG functionalised graphene, graphene composite, and/or polymer graphene aerogel.

17. The membrane according to claim 14, wherein the graphene or derivative thereof is graphene oxide.

18. The membrane according to claim 14, wherein the atomic oxygen content of the two-dimensional material is the range of from 1% to 60%.

19. The membrane of claim 1, wherein the composition comprises fibres.

20. The membrane of claim 11, wherein the coating composition is coated onto the substrate using bar coating, flexo-coating, ink-jet printing, screen coating or slot coating.

21. The membrane of claim 1, wherein the active layer comprises multiple coating layers.

22. The membrane of claim 1, wherein the coating layers of the active layer comprise a gradient of decreasing, increasing or variable reduction level in the two-dimensional material through the active layer.

23. The membrane of claim 1, wherein the two-dimensional material is treated by exposing the two-dimensional material to radiation, chemical treatment, pressure treatment and/or thermal treatment.

24. The membrane of claim 1, wherein the two-dimensional material is treated by exposing the two-dimensional material to laser radiation.

25. The membrane of claim 1, wherein the two-dimensional material is chemical treated.

26. The membrane of claim 1, wherein the two-dimensional material is treated by subjecting the two-dimensional material to thermal treatment applied to the coating composition or to treatment of the membrane post coating.

27. The membrane of claim 1, wherein the atomic oxygen and/or nitrogen content of the treated two-dimensional is from 0% to 65%.

28. The membrane of claim 1, wherein the active layer comprises a first layer comprising two-dimensional material having a first oxygen content and a second layer comprising two-dimensional material having a second oxygen content, wherein the first and second oxygen contents are different.

29. The membrane of claim 28, wherein the first oxygen content is between 30 and 50% and the second oxygen content is between 1 and 30%.

30. The membrane of claim 28, wherein the layer comprising the first oxygen content is arranged between the substrate and the second layer comprising the second oxygen content.

31. The membrane of claim 1, wherein the treated two-dimensional material has a thermal conductivity in a range of from 0.1 W/mK to 6,000 W/mK.

32. The membrane of claim 1, wherein the treated two-dimensional material has an electrical conductivity of in a range of from 1×10⁻⁶ S/m to 600,000 S/m.

33. The membrane of claim 1, wherein the treated two-dimensional material comprises amino groups; aliphatic amino groups, porphyrin-functionalised secondary amino groups, and/or 3-amino-propyltrialkoxysilane groups.

34. The membrane of claim 1, wherein the treated two-dimensional material comprises amino-based graphene , isocyanate modified GO, octadecylamine functionalised reduced graphene oxide, polymer graphene aerogel, azide-, alkyne-functionalised GO, poly(allylamine) modified, DNA or protein modified (non-covalent).

35. The membrane of claim 1, wherein the treated two-dimensional material comprises functional groups attached toward the edge of the two-dimensional material, such as NO₂, —NH₂, —SO₃H, halide, —Na, —MgBr and/or —SH groups.

36. (canceled)

37. The membrane of claim 1, wherein treatment of the two-dimensional material forms channels in the form of closed or open loop, pattern of an electronic circuit, a grid and/or artistic patterns.

38. (canceled)

39. The membrane of claim 1, wherein the membrane is for oil/water separation, molecule separation, pharmaceutical separation for removal of pharmaceutical residues in the aquatic environment, drug separation, bio-filtration, for example separation between micro-organisms and water, desalination, suitably sea water desalination, or selective ion separation, and nuclear waste water separation for removal of nuclear radioactive elements from nuclear waste water, heavy metal removal, bio-refinery, laundry water treatment, milk condensation, for blood treatment such as physiological separation to replace damaged kidney filter and blood separation, and/or separation of bio-platform molecules derived from sources such as plants, for industrial water treatment, for example, industrial laundry waste water, food and beverage manufacturing, chemical production waste water, paper processing, waste water from landfill and agriculture, dairy and cheese production including brine water treatment from cheese production, milk concentration, protein recovery from crops such as potatoes.

40. The membrane of claim 1, wherein the membrane is for water separation comprising desalination or oil and water separation, or for chemical separation.

41. The membrane of claim 1, wherein the two-dimensional material is treated after application of the two-dimensional material to the substrate layer.

42. The membrane of claim 11, wherein the two-dimensional material is treated by subjecting the two-dimensional material to thermal treatment applied to the coating composition or to treatment of the membrane post coating.
